(19) United States
(12) Patent Application Publication
(10) Pub. No.: US 2025/0280871 A1
(43) Pub. Date: Sep. 11, 2025

(54) CONTAINER

(71) Applicant: NICOVENTURES TRADING LIMITED, London (GB)

(72) Inventor: Sean LUKAN, Winston-Salem, NC (US)

(21) Appl. No.: 18/858,950

(22) PCT Filed: Apr. 21, 2023
(86) PCT No.: PCT/GB2023/051052

§ 371 Date: Oct. 22, 2024

(30) Foreign Application Priority Data
Apr. 22, 2022 (GB) 2205863.0

(51) Int. Cl. A24F 15/18; A24F 15/01; A24F 23/00; G06F 21/31

(52) U.S. Cl. CPC A24F 15/18; A24F 15/01; A24F 23/00; G06F 21/31

(57) ABSTRACT

There is provided a container for delivery systems and/or aerosol generating material comprising: a body surrounding a cavity and an opening in the body through which the cavity can be accessed; a closing arranged to openably close the opening in the body; a lock for controllably locking the closing; control circuitry for changing a state of the lock; user authorisation means for verifying a user; and, tamper prevention means arranged to impact the cavity when the closing is opened when the lock is in a locked state, wherein the control circuitry is arranged to change a state of the lock to unlock in response to receiving a signal originating from the user authorisation means associated with an authorised user.

### TECHNICAL FIELD

The present invention relates to a container, a system, a method of preventing unauthorised access to a container for delivery systems and/or aerosol generating material and containing means.

### BACKGROUND

Containers for aerosol generating material are known. Some aerosol generating material for use with aerosol provision devices, delivery systems or aerosol provision systems are contained in containers prior to use. Similarly, some modern oral products are contained in containers that are opened by a user prior to use. Some modern oral products are age restricted. Control over use of such aerosol generating material and modern oral products may be desirable for manufacturers and users.

The present invention is directed toward solving some of the above problems.

### SUMMARY

Aspects of the invention are defined in the accompanying claims.

In accordance with some embodiments described herein, there is provided a container for delivery systems and/or aerosol generating material comprising: a body surrounding a cavity and an opening in the body through which the cavity can be accessed; a closing arranged to openably close the opening in the body; a lock for controllably locking the closing; control circuitry for changing a state of the lock; user authorisation means for verifying a user; and, tamper prevention means arranged to impact the cavity when the closing is opened when the lock is in a locked state, wherein the control circuitry is arranged to change a state of the lock to unlock in response to receiving a signal originating from the user authorisation means associated with an authorised user.

Such an arrangement is able to verify a potential user of the aerosol generating material or delivery system. In particular, the container locks and only allows access to users that satisfy user verification. Where users do not satisfy user verification, the container lock is not changed to an accessible (unlocked) state. In this way, unsuitable users are prevented from accessing the contents of the container.

The container has control circuitry for receiving data from the user authorisation means and providing signals to control the state of the lock (either locked or unlocked). The container advantageously also has tamper prevention means for impacting the cavity of the container when the closing is opened while the lock is in the locked state. The synergistic interaction of these elements leads to a secure container for goods, which discourages user interference with by virtue of the tamper prevention means.

In this way, a valid user may have full access to any items within the container, while an invalid user is prevented from access. This provides a safe and secure system for storing aerosol generating material and delivery systems for a user.

In accordance with some embodiments described herein, there is provided a system comprising:
a container for delivery systems and/or aerosol generating material comprising: a body surrounding a cavity and an opening in the body through which the cavity can be accessed; a closing arranged to openably close the opening in the body; a lock for controllably locking the closing; control circuitry for changing a state of the lock; and, tamper prevention means arranged to impact the cavity when the closing is opened when the lock is in a locked state, and user authorisation means for verifying a user, wherein the control circuitry is arranged to change a state of the lock to unlock in response to receiving a signal originating from the user authorisation means associated with an authorised user.

In accordance with some embodiments described herein, there is provided method of preventing unauthorised access to a container for delivery systems and/or aerosol generating material, the method comprising: verifying, by user authorisation means, a user attempting to access a container of delivery systems and/or aerosol generating material contained in use in a cavity of the container; receiving, by control circuitry, a signal originating from the user authorisation means in response to receiving a signal originating from the user authorisation means, performing at least one of: changing, by the control circuitry, a state of a lock of the container; and, activating, by the control circuitry, user authorisation means.

In accordance with some embodiments described herein, there is provided containing means for delivery systems and/or aerosol generating material comprising: a body surrounding a cavity and access means in the body through which the cavity can be accessed; closing means arranged to openably close the access means in the body; locking means for controllably locking the closing means; control means for changing a state of the locking means; user authorisation means for verifying a user of delivery systems and/or aerosol generating material; and, tamper prevention means arranged to impact the cavity when the closing means is opened when the locking means is in a locked state, wherein the control means is arranged to change a state of the locking means to unlock in response to receiving a signal originating from the user authorisation means associated with an authorised user.

### DESCRIPTION OF DRAWINGS

The present teachings will now be described by way of example only with reference to the following figures:

FIG. 1 is a schematic view of a container according to an example;

FIG. 2 is a schematic view of a container according to an example;

FIG. 3 is a schematic view of a container according to an example;

FIG. 4 is a schematic view of a system according to an example; and,

FIG. 5 is a flow diagram according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to a container that in use contains aerosol generating material or delivery systems that may be used alongside aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

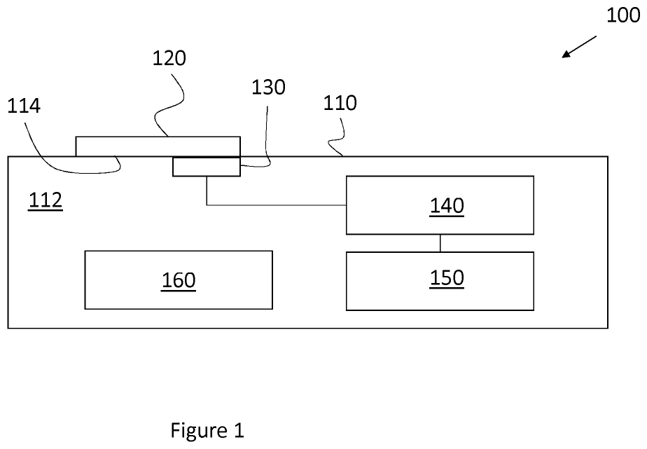

FIG. 1 illustrates a schematic view of an example of a container 100 for delivery systems and/or aerosol generating material. The container 100 has a body 110 surrounding a cavity 112 and an opening 114 in the body 110 through which the cavity 112 can be accessed. The container 100 has a closing 120 arranged to openably close the opening 114 in the body 110. The container 100 has a lock 130 for controllably locking the closing 120. The container 100 has control circuitry 140 for changing a state of the lock 130. The container 100 also has user authorisation means 150 for verifying a user. The container 100 has tamper prevention means 160 arranged to impact the cavity 112 when the closing 120 is opened when the lock 130 is in a locked state. The control circuitry 140 is arranged to change a state of the lock 130 to unlock in response to receiving a signal originating from the user authorisation means 150 associated with an authorised user.

The closing 120 may be a door or flap or similar movable element that may cover completely the opening 114, to prevent access to a user without safely unlocking the lock 130 and moving the closing 120 to reveal the opening 114. The cavity 112 may be accessed via the opening 114 once the closing 120 is moved.

The lock 130 is connected to the control circuitry 140 so that the control circuitry 140 can send a signal to the lock 130 to change a state of the lock (i.e. between locked and unlocked). In the unlocked state, the closing 120 can be moved to allow access to the cavity 112 via the opening 114. In the locked state, the closing 120 cannot be moved, without the user attempting some form of tampering with the container 100. The lock 130 may contain a physical locking element such as a bolt and latch, or may contain an electrical locking element such as use of electromagnets or the like. In either instance, the lock 130 allows a change of state on receipt of a signal from the control circuitry 140.

The user authorisation means 150 may be at least one of: a face scanner; a projector scanner; a microphone; a fingerprint scanner; an iris scanner; and, a communication module for communicating with at least one of: a remote database; a remote computing arrangement; an onboard database; and, an onboard computing arrangement.

In the example of a face scanner (or camera or the like), the user authorisation means 150 may factor in aspects such as lines in the face, bags under the eyes, and prevalence of e.g. in males, facial hair to provide a user authorisation means. Such factors can be used to indicate a probable age range of the user of the container 100. The user authorisation means 150 may perform an analysis of the data taken of the user, and provide a signal to the control circuitry 20 140 indicating whether the user is of a likely suitable or likely unsuitable age for use of (i.e. access to) the container. Alternatively or additionally, the camera may be used to inspect a user's identification, such as a passport to the like, to detect an age of the user. If there is an image on the identification, this can be compared against the user's face using the camera.

Other user authorisation means may be used, and the container 100 may use more than one to increase the robustness of the access criteria. The user can be verified by the user authorisation means 150 and therefore the container 100 only provides access to verified or authorised users.

The container 100 contains tamper prevention means 160. This may be arranged to impact the cavity 122 when a tamper attempt is made by a user (for example an unauthorised user that is unable to access the container 100 via satisfying the user authorisation means 150).

The tamper prevention means 160 is not shown as connected to the control circuitry 140 in FIG. 1, though the tamper prevention means 160 may be. The tamper prevention means 160 may contain a sensor that detects excessive rough handling, indicating an unauthorised access attempt is being made, and then impacts the cavity 112. The tamper prevention means 160 may comprise a haptic sensor to detect excessive movement, or comprise a light sensor to detect when light enters the cavity 112 while the lock 130 is in the locked state (indicating an unauthorised attempt to access the container 100). Such detections may lead to the tamper prevention means 160 impacting the cavity in some way. The tamper prevention means 160 may be a physical impact, such as crushing the aerosol generating material or the like contained in the cavity 112 or may be a chemical impact, such as ink or a compound being released onto the goods in the container 100. The tamper prevention means 160 may be connected to the closing 120 and detect when the closing 120 is opened while the lock 130 is in a locked state. Each of these indicates an unauthorised access attempt is being made.

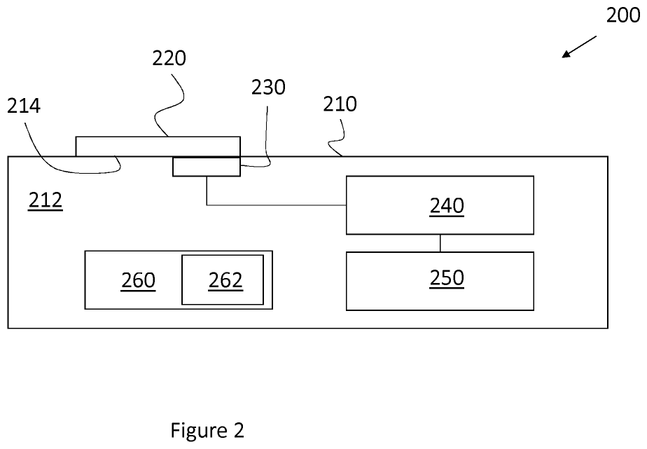

Referring now to FIG. 2, there is a shown a similar container 200 to the container 100 of FIG. 1. Similar features, to those features used in FIG. 1, are shown with the reference numerals increased by 100. For example, the container 100 of FIG. 1 is similar to the container 200 of FIG. 2. Similar or identical features may not be discussed for conciseness.

The container 200 of FIG. 2 has a body 210, with a cavity 212 and an opening 214, a closing 220 covering the opening 214, a lock 230 to lock the closing 220 and control circuitry 240 connected to the lock 230. The container 200 also has user authorisation means 250 connected to the control circuitry 240 and tamper prevention means 260 comprising an tamper prevention means element 262.

The tamper prevention means element 262 may be a physical elements such a blunt crushing item, or a sharp cutting or slashing item. This may activate on recognition of a tamper attempt by a user and thereby destroy the contents of the container such as aerosol generating material or a delivery system (such as snus) or the like. The aerosol generating material or delivery system may be in a bag or the like, a tearing element may destroy the bag rendering the aerosol generating material or delivery system impossible or extremely difficult, or highly undesirable to use.

The tamper prevention means element 262 may be chemical such as an ink that is released to render the contents of the container unusable. The tamper prevention means element 262 may be a compound that is arranged to chemically alter delivery systems or aerosol generating material contained in use in the container 200. This may be for example a salt that renders nicotine in delivery systems inert. In this way, the compound is not biochemically dangerous to ingest, however the delivery system would not long release nicotine, rendering the delivery system highlight unattractive to an unauthorised user following an unauthorised access attempt (an attempted tampering event). The tamper prevention means element 262 may be a compound that reduces the bioavailability of nicotine in the aerosol generating material or delivery system to around zero.

The tamper prevention means 260 in an example is arranged to structurally alter or damage delivery systems and/or aerosol generating material, contained in use in the container 200, in response to contact with the delivery systems and/or aerosol generating material. This may be via physical or chemical methods.

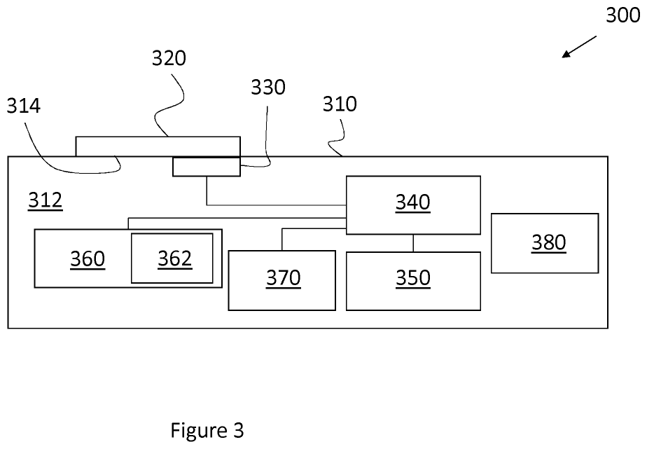

Referring now to FIG. 3, there is a shown a similar container 300 to the container 200 of FIG. 2. Similar features, to those features used in FIG. 2, are shown with the reference numerals increased by 100. For example, the container 200 of FIG. 2 is similar to the container 300 of FIG. 3. Similar or identical features may not be discussed for conciseness.

The container 300 of FIG. 3 has a body 310, with a cavity 312 and an opening 314, a closing 320 covering the opening 314, a lock 330 to lock the closing 320 and control circuitry 340 connected to the lock 330. The container 300 also has user authorisation means 350 connected to the control circuitry 340 and tamper prevention means 360 comprising an tamper prevention means element 362.

The container 300 also has a movement sensor 370 arranged to detect movement of the container 300 by a user, wherein when movement of the container 300 exceeds a predetermined limit, the moment sensor 370 is arranged to send a signal to activate the tamper prevention means 360. The movement sensor 370 may be directly connected to the tamper prevention means 360. Alternatively, the movement sensor 370 may be directly connected to the control circuitry 340 that may forward signals from the movement sensor 370 to the tamper prevention means 360. As mentioned above, attempts to break into the container 300 are likely to contain distinctive movements that are not indicative of normal use of the container 300. These can be detected by the movement sensor 370 and used to indicate a tamper attempt is in progress. This can be used by the container 300 to provide a warning to the user to cease tamper attempts and if tamper attempts do not cease, to release the tamper prevention means element 362 into or onto the aerosol generating material or delivery systems contained in use in the container cavity 312. The tamper prevention means 360 may activate only after a predetermined number of tamper attempts have been recognised, or after a warning ahs been provided and a further tamper attempt is recognised.

The container 300 also has a light sensor 370 arranged in the cavity 314. The light sensor 370 is arranged to send a signal to activate the tamper prevention means 360 when the light sensor 370 detects light when the lock 330 is in a locked state. If light enters cavity 314, while the lock 330 is in the locked state, it is a strong indication that the container 300 has been tampered with and compromised and therefore the tamper prevention means 360 can activate to prevent unauthorised access to the cavity 314 and the aerosol generating material or delivery systems contained therein.

In examples, the container may have one or more sensors as noted above, such as light or movement sensors. These provide increased reliability on the decision as to whether a user is tampering with the container 300 or whether the container 300 is being roughly handled but not tampered with. This therefore provides a more reliable container 300 that acts accordingly to the situation, that of not activating the tamper prevention means 360 when it is not required and that of activating the tamper prevention means 360 when it is required.

Such sensors may be routed to the tamper prevention means directly or via the control circuitry. The specific electrical arrangement is not essential to the form of the container. Routing signals via the control circuitry allows the control circuitry to assess signals from multiple sensors and ascertain more accurately (than from one sensor's reading alone) whether a tamper attempt is underway or not.

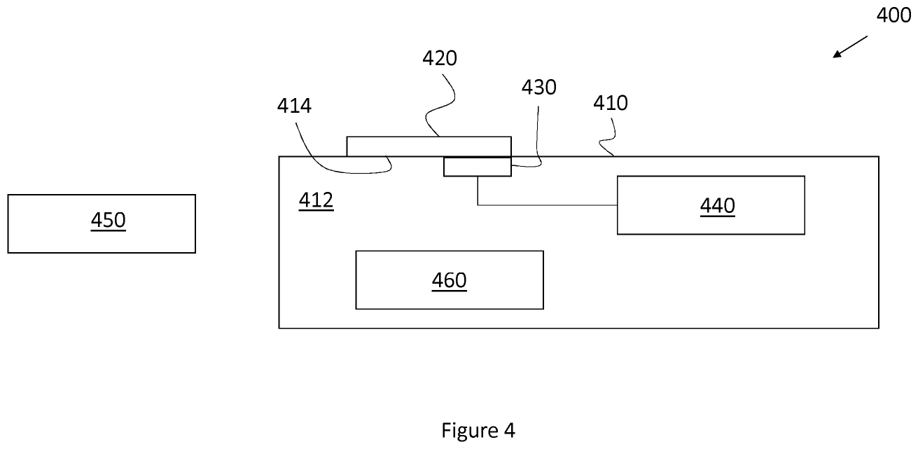

Referring now to FIG. 4, there is a shown a similar system 300 to the container 100 of FIG. 1. Similar features, to those features used in FIG. 1, are shown with the reference numerals increased by 300. For example, the container 100 of FIG. 1 is similar to the system 400 of FIG. 4. Similar or identical features may not be discussed for conciseness.

The system 400 of FIG. 4 has a container 410 that has a body, with a cavity 412 and an opening 414, a closing 420 covering the opening 414, a lock 430 to lock the closing 420 and control circuitry 440 connected to the lock 430. The container 410 also has tamper prevention means 460.

The system 400 also has user authorisation means 450 for verifying a user. The user authorisation means 450 may communicate to the control circuitry 440 of the device 410 wirelessly, or via a separate hard wired connection, e.g. via USB connection or the like. The user authorisation means 450 is not integral with the device 410. The user authorisation means 450 may be a separate smart device that the user can use to verify themselves prior to accessing the container 410. The user authorisation means 450 may communicate with the device 410 via an app that may, for example, be arranged to use any of Bluetooth™, Bluetooth Low Energy™, ZigBee™, WiFi™, Wifi Direct™, GSM, 2G, 3G, 4G, 5G, LTE, NFC, or RFID.

Having a separate device for user authorisation simplifies the construction of the device 410. This also allows the functionality of a device already in the possession of the user to be used and therefore decrease the cost of the device 410.

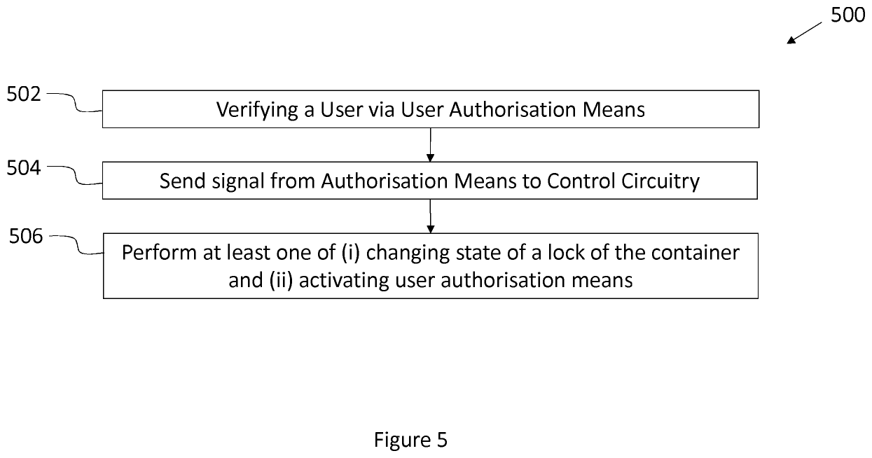

FIG. 5 shows a method 500 of preventing unauthorised access to a container for delivery systems and/or aerosol generating material. The method involves verifying, by user authorisation means, a user attempting to access a container of delivery systems and/or aerosol generating material contained in use in a cavity of the container 502. The method involves sending a signal originating from the user authorisation means to control circuitry 504. The method then involves performing at least one of changing, by the control circuitry, a state of a lock of the container; and, activating, by the control circuitry, user authorisation means 506.

In this way, the user is made to pass user authorisation prior to being provided access to the container via the changing of the lock state, to e.g. unlocked. In the unlocked state, the user may be able to access the container via moving a closing to provide access to an opening that is connected to the cavity.

To prevent attempted hack attempts, or tamper attempts, the system may have sensors or the like to detect likely tamper attempts, and the method involves activating tamper prevention means to destroy or render unusable, or highly undesirable, the material in the container. This provides a highly roust security system within which to store aerosol generating material or delivery systems such as snus or the like.

The method and container disclosed herein enable protection over the use of aerosol generating material or delivery systems and discourage tamper attempts to access such aerosol generating material or delivery systems. This improves the user experience of the container and the safety of general use of the container.

The container disclosed herein has user authorisation means that is capable of authorising a user. This data obtained by the user authorisation means may be processed by a number of components able to compare the data against a database (for example) of authorised users. This data may be analysed on-board the container by e.g. control circuitry. The control circuitry may then analyse the signal and evaluate whether to allow or inhibit or prevent access to the container. In another example, the data from the user authorisation means may be sent to a remote database or server for analysis. In such an example, the container (or the user authorisation means itself) may have (or be) a communications module for communicating with the remote database or server. The remote database or server may perform the analysis and provide a signal to the communications module. The signal ultimately sent to the control circuitry by the communication module may be one indicating the control circuitry should or should not allow access to the container. This allows for more complex analysis to be performed off the container, which may render the container more cost efficient to produce.

The term “in response to” is used herein to indicate a second event (such as a signal or change of state of a lock of the container) that occurs subsequent to a first event. The second event may occur at a later time, after a predetermined time, or immediately after the first event.

The container herein is described as comprising several components that enable several advantages. The components may be disclosed as on-board the container or within the container. The components may be distributed and therefore not necessarily be located on-board the container. The functionality of the container can be provided by communicatively connected components, and such communication may be wireless, enabling such distribution. At which point it is reasonable to foresee that a distributed array of components will operate in the manner of the container disclosed herein. Components of the container may be contained in a further device such as a smartphone, computer, or remote server or the like.

Thus there has been described a container for delivery systems and/or aerosol generating material comprising: a body surrounding a cavity and an opening in the body through which the cavity can be accessed; a closing arranged to openably close the opening in the body; a lock for controllably locking the closing; control circuitry for changing a state of the lock; user authorisation means for verifying a user; and, tamper prevention means arranged to impact the cavity when the closing is opened when the lock is in a locked state, wherein the control circuitry is arranged to change a state of the lock to unlock in response to receiving a signal originating from the user authorisation means associated with an authorised user.

Delivery systems may take many forms. Examples are cigarettes in which tobacco is combusted, heat-not-burn products (such as Tobacco Heating Products (THPs) and Carbon-tipped Tobacco Heating Products (CTHPs)) in which a solid material is heated to generate aerosol without combusting the material, vapour products (commonly known as “electronic cigarettes” or “e-cigarettes”) in which liquid material is heated to generate aerosol, hybrid products that are similar to vapour products though the aerosol generated from the liquid material passes through a second material (such as tobacco) to pick up additional constituents before reaching the user, oral products such as snus, snuff, gums, gels, sprays, and other delivery systems such as patches. The container disclosed herein may hold any of these.

The container disclosed herein may hold aerosol-free delivery systems that deliver at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine. The container disclosed herein may hold components storing substances, the substances may be formed of material comprising one or more active constituents, one or more flavours, one or more aerosol-former materials, and/or one or more other functional materials.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. A container for delivery systems and/or aerosol generating material comprising:
a body surrounding a cavity and an opening in the body through which the cavity can be accessed;
a closing arranged to openably close the opening in the body;
a lock for controllably locking the closing;
control circuitry for changing a state of the lock;
user authorisation means for verifying a user; and,
tamper prevention means arranged to impact the cavity when the closing is opened when the lock is in a locked state,
wherein the control circuitry is arranged to change a state of the lock to unlock in response to receiving a signal originating from the user authorisation means associated with an authorised user.

2. A container according to claim 1, wherein the lock comprises at least one of a physical locking element and an electrical locking element.

3. A container according to claim 1, wherein the tamper prevention means comprises at least one compound arranged to be released into the cavity when the closing is opened when the lock is in a locked state.

4. A container according to claim 3, wherein the at least one compound is arranged to chemically alter delivery systems and/or aerosol generating material, contained in use in the container, in response to contact with the delivery systems and/or aerosol generating material.

5. A container according to claim 4, wherein the at least one compound is arranged to render delivery systems and/or aerosol generating material, contained in use in the container, chemically inert in response to contact.

6. A container according to claim 1, wherein the tamper prevention means is arranged to structurally alter or damage delivery systems and/or aerosol generating material, contained in use in the container, in response to contact with the delivery systems and/or aerosol generating material.

7. A container according to claim 1, further comprising a movement sensor arranged to detect movement of the container by a user, wherein when movement of the container exceeds a predetermined limit, the moment sensor is arranged to send a signal to activate the tamper prevention means.

8. A container according to claim 1, further comprising a light sensor arranged in the cavity,
wherein the light sensor is arranged to send a signal to activate the tamper prevention means when the light sensor detects light when the lock is in a locked state.

9. A container according to claim 1, wherein the user authorisation means comprises at least one of: a face scanner; a projector scanner; a microphone;
a fingerprint scanner; an iris scanner; and, a communication module for communicating with at least one of: a remote database; a remote computing arrangement; an onboard database; and, an onboard computing arrangement.

10. A system comprising:
a container for delivery systems and/or aerosol generating material comprising:
a body surrounding a cavity and an opening in the body through which the cavity can be accessed;
a closing arranged to openably close the opening in the body;
a lock for controllably locking the closing;
control circuitry for changing a state of the lock; and,
tamper prevention means arranged to impact the cavity when the closing is opened when the lock is in a locked state, and
user authorisation means for verifying a user,
wherein the control circuitry is arranged to change a state of the lock to unlock in response to receiving a signal originating from the user authorisation means associated with an authorised user.

11. A system according to claim 10, wherein the user authorisation means comprises at least one of: a face scanner; a projector scanner; a microphone; a fingerprint scanner; an iris scanner; a mobile device; and, a communication module for communicating with at least one of: a remote database; a remote computing arrangement; an onboard database; and, an onboard computing arrangement.

12. A system according to claim 10, wherein the user authorisation means is not integral with the container.

13. A method of preventing unauthorised access to a container for delivery systems and/or aerosol generating material, the method comprising:
verifying, by user authorisation means, a user attempting to access a container of delivery systems and/or aerosol generating material contained in use in a cavity of the container;
receiving, by control circuitry, a signal originating from the user authorisation means
in response to receiving a signal originating from the user authorisation means, performing at least one of:
changing, by the control circuitry, a state of a lock of the container; and,
activating, by the control circuitry, user authorisation means.

14. A method according to claim 13, further comprising:
detecting an unauthorised access attempt by a user,
activating the tamper prevention means to be released into the cavity.

15. A method according to claim 14, wherein detecting an unauthorised access attempt comprises at least one of:
detecting, by a light sensor located in a cavity of the container, light in the cavity; and,
detecting, by a movement sensor, movement of the container that exceeds a predetermined limit.

16. A method according to claim 14, wherein activating the tamper prevention means comprises at least one of:
releasing a chemical into the cavity to chemically alter the delivery systems and/or aerosol generating material in the cavity; and,
activating a mover to structurally alter or damage the delivery systems and/or aerosol generating material in the cavity.

17. A method according to claim 14, wherein verifying, by user authorisation means, a user attempting to access a container of delivery systems and/or aerosol generating material contained in use in a cavity of the container comprises verification using at least one of:
a face scanner; a projector scanner; a microphone; a fingerprint scanner; an iris scanner; a mobile device; and, a communication module for communicating with at least one of:
a remote database; a remote computing arrangement; an onboard database; and, an onboard computing arrangement.

18. A method according to claim 17, wherein receiving, by control circuitry, a signal originating from the user authorisation means comprises at least one of:
(i) receiving, by control circuitry, a signal direct from the user authorisation means; and,
(ii) sending by a communication module a signal to at least one of:
a remote database;
a remote computing arrangement;
an onboard database; and,
an onboard computing arrangement,
receiving, by a communication module, a signal from the at least one of:
a remote database;
a remote computing arrangement;
an onboard database; and,
an onboard computing arrangement,
and sending a signal, by a communication module, to the control circuitry.

19. (canceled)
